(19) United States
(12) Patent Application Publication
(10) Pub. No.: US 2025/0030758 A1
(43) Pub. Date: Jan. 23, 2025

(54) System and Method for Resource Scheduling in a Distributed Computing System

(71) Applicant: Elemento S.R.L., Cuneo (CN) (IT)

(72) Inventor: Gabriele Gaetano FRONZÈ, Cuneo (IT)

(21) Appl. No.: 18/716,028

(22) PCT Filed: Nov. 24, 2022
(86) PCT No.: PCT/IB2022/061378

§ 371 Date: Jun. 3, 2024

(30) Foreign Application Priority Data
Dec. 13, 2021 (IT) 102021000031202

(51) Int. Cl. H04L 67/1008; H04L 67/101

(52) U.S. Cl. CPC H04L 67/1008; H04L 67/101

(57) ABSTRACT

A method for sharing and selecting a shared resource in a cloud computing system includes a first step in which a server of the system receives a message requesting a resource, and a second step in which said server transmits a reply message at a predetermined instant of transmission computed as a function of a utilization index of the shared resources included in the server. The method for selecting a resource includes a first step in which a user equipment transmits a message requesting a resource, a second step in which the user equipment receives a first reply message at a first instant of reception from a first server, and a third step in which the user equipment receives a second reply message at a second instant of reception from a second server.

### BACKGROUND OF THE DISCLOSURE

### 1. The Field of the Disclosure

The present invention relates to a method for sharing and selecting a resource in a cloud computing system. The present invention also relates to a system, a server, a user equipment and a computer program for sharing and selecting a resource in a cloud computing system.

### 2. THE RELEVANT TECHNOLOGY

In the present description, the term “cloud computing” or the equivalent terms “computing cloud” or “cloud”, will refer to that computing paradigm according to which a plurality of resources and/or services held from a plurality of providers (also referred to as servers in the present description) are offered to a plurality of user equipments (also referred to as clients, terminals, or, more simply, users in the present description) over a telecommunications network. Such resources and/or services may be, for example, physical or virtual hardware resources, storage resources, computational resources, data transmission resources, software services, etc. In the course of the present description, the term “resource” will refer to any type of computing resource or service commonly available from currently known cloud computing systems. It is understood that the present invention is not limited to a particular type of resource and/or service provided by the cloud computing system, since it is also applicable, without requiring any modification, to any type of resources or services offered by the cloud system. It is also understood that the present invention is not limited to cloud computing systems wherein there is a clear separation between providers and users (i.e., between servers and clients); on the contrary, the present invention can be applied without distinction to any type of cloud computing system. For example, the present invention is also applicable to cloud computing systems wherein a single apparatus can act both as a server and as a client (e.g., a peer-to-peer system).

The architecture of the cloud computing systems known in the art usually comprises one or more servers operatively connected to one another by means of a telecommunications network such as, for example, the Internet global network or a local data network; each server belonging to a cloud computing system normally holds one or more resources configured to be made available to a plurality of final users; according to techniques known in the art, the users of a cloud system can use the services made available by the cloud system via one or more user equipments operatively connected to the cloud computing system by means of said telecommunications network. Generally, the process of allocating resources to final users is started upon a specific request issued by an individual user; to this end, the cloud computing systems known in the art usually comprise a resource management system which can administer and allocate the resources held by the servers of the cloud system as a function of the requests generated by the users. Such resource management systems typically comprise a plurality of modules including, for example, a user interface configured for receiving and handling one or more resource requests generated by one or more final users, a “control plane” configured for managing, among other things, the process of searching the cloud computing system for the resources requested by one or more users, a “hypervisor” configured for creating one or more virtual machines capable of partitioning the resources residing on a specific server for one or more final users.

One of the essential functions performed by the resource management systems of the cloud computing systems known in the art consists of searching and/or possibly classifying the resources held by the servers of the cloud system. In particular, according to techniques known in the art, a resource management system can be configured for monitoring the resources available in a cloud system, so as to be able to ascertain, at any time, the position and utilization of such resources (i.e., where the resources offered by the system servers are located and the allocation state thereof). This operation can be carried out in a centralized manner by one or more resource management systems, which can be configured for creating in real time a catalogue of the resources available in the cloud system; for example, a centralized resource management system may be configured for updating the centralized resource catalogue in a proactive manner and at regular intervals, so as to constantly have an up-to-date view of all the resources held by the system and their utilization state. The centralized resource management systems known in the art suffer from several problems, which are mainly related to the concentration of the resource management functions in a limited set of apparatuses. For example, in order to ensure a certain degree of resilience in case of possible malfunctions of one or more apparatuses of the cloud computing system, the centralized resource catalogue and the functions of the resource management system may be replicated and stored in parallel on a plurality of distinct apparatuses; in this way, for example, in the event of a sudden failure of one of the apparatuses that store a copy of the centralized resource catalogue, the resource management system will be able to continue providing the service using a replica of the resource catalogue stored on an alternative apparatus. This redundancy of the resource management system and of the centralized catalogue on a plurality of apparatuses, while it ensures a certain degree of resilience of the cloud system, is very inefficient in terms of costs and communication overhead, caused by each of the replicas of the resource management system. This redundancy of the resource management system is also inefficient from a computational viewpoint, in that the number of apparatuses configured for providing the centralized management services is not linearly scalable with the number of managed resources; such inefficiency proves especially problematical in small cloud computing systems. A further problem ensuing from centralized management of the resources of a cloud computing system concerns the updating of the centralized catalogue following the installation of new shared resources (e.g., addition of a new server or a new shared resource); in this case, according to techniques known in the art, the centralized catalogue is often updated in a retroactive manner (i.e., after the installation of the new resources); this inevitably results in a time transient during which the centralized catalogue does not reflect the actual availability of the resources of the cloud computing system.

Alternatively, aiming at solving the problems suffered by centralized resource management systems, resources may be searched for within the cloud computing system in a distributed manner without using a centralized resource catalogue; in such a case, the resources requested by one or more users may be searched for extemporaneously, according to the individual user's needs. For example, a given resource may be searched for directly by an individual user by means of a communication protocol established, for example, at application level between the servers of the cloud system and the user. Generally, such communication protocols are configured for searching for resources through one or more resource search messages created by the individual user and sent to one or more servers of the cloud system; based on the internal availability of the requested resources, each server may be configured for creating and sending to the user a reply message containing, for example, a list of the available resources requested by the user. Finally, based on the reply messages received, the user can autonomously select one or more servers of the cloud system in order to allocate the resources.

While they offer several advantages over centralized systems, distributed resource management systems still suffer from a few problems related to the absence of a centralized entity having a complete and up-to-date view of the cloud system. For example, the absence of such a centralized entity makes it difficult to implement any balanced resource allocation strategy within the servers of the cloud computing system (also referred to as cloud load balancing, or, more simply, as load balancing or scheduling in the present description); in particular, according to the distributed resource search protocols known in the art, there is no possibility of allocating resources in accordance with a predetermined balanced resource allocation strategy. For example, since server selection is made autonomously by the individual user only on the basis of the reply messages received from the servers of the system, resource allocation within the cloud systems known in the art is random and often unbalanced. Such an uneven utilization of the servers of the cloud system may lead to overload problems in some servers, resulting in other servers of the cloud system being underexploited. An additional difficulty in managing balanced allocation strategies in distributed search systems is due to the necessity of maintaining a predetermined degree of safety and privacy as to the state of allocation of the servers of the cloud system; for example, in order to protect the cloud system against cyberattacks, it is preferable to avoid disclosing to individual users any explicit information about the quantity and configuration of the resources residing in each server.

For example, United States patent application US2002143944A1 describes a resource sharing system based on a distributed search protocol. Such resource search protocol does not envisage disclosing any information about the workload of each server, nor implementing any strategy for balancing the load at system level.

### SUMMARY OF THE DISCLOSURE

It is one object of the present invention to provide a method, a system, a server, a user equipment and a computer program for sharing and selecting a resource in a cloud computing system which can overcome the drawbacks of the prior art. In particular, it is one object of the present invention to provide a method, a system, a server, a user equipment and a computer program which can implement one or more balanced resource allocation strategies in a cloud computing system based on a distributed resource search protocol. It is a further object of the present invention to implement one or more balanced resource allocation strategies in a cloud computing system while avoiding explicit disclosure of information about the quantity and load of the resources available in each server.

### BRIEF DESCRIPTION OF THE DRAWINGS

The above-mentioned objects are achieved by the present invention through a method, a system, a server, a user equipment and a computer program having the features set out in the appended claims, which are an integral part of the present description. Further objects, features and advantages of the present invention will become apparent in light of the following detailed description and of the annexed drawings, provided merely by way of non-limiting example, wherein:

FIG. 1 shows a diagram of the cloud computing system of the present invention;

FIG. 2 shows a block diagram of a service provider comprised in the cloud computing system of the present invention;

FIG. 3 shows a block diagram of a user equipment of the present invention;

FIG. 4 shows a diagram of a resource management system of a cloud computing system;

FIG. 5 shows an example of the steps of a protocol for sharing and selecting a resource;

FIG. 6 shows a diagram of a method for sharing a resource in a cloud computing system according to the present invention;

FIG. 7 shows a diagram of a method for selecting a resource in a cloud computing system according to the present invention.

### DETAILED DESCRIPTION OF THE PREFERRED EMBODIMENTS

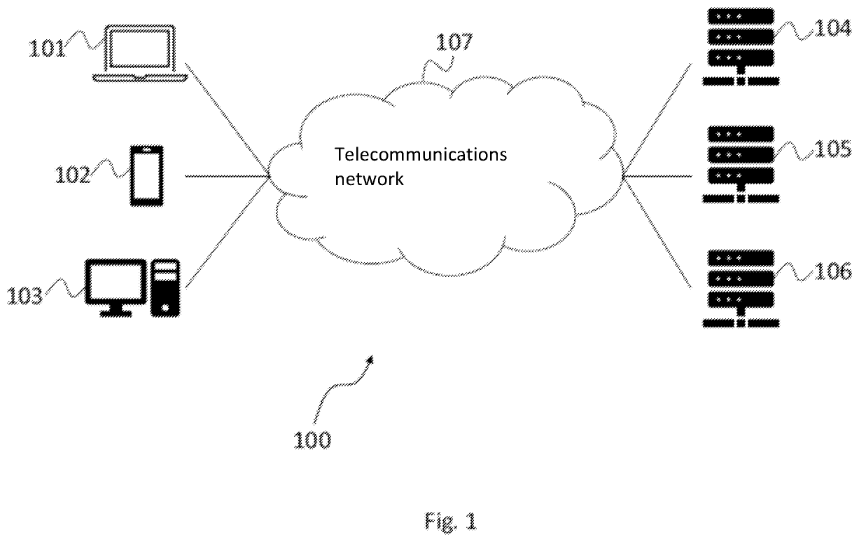

Referring now to the annexed drawings, reference numeral 100 in FIG. 1 designates as a whole a cloud computing system according to the present invention. As indicated in FIG. 1, the cloud computing system 100 comprises a plurality of servers 104, 105, 106 operatively connected to one another by means of a telecommunications network 107. Each one of the servers 104, 105, 106 can be configured to comprise one or more resources which can be shared by a plurality of user equipments 101, 102, 103 operatively connected to said telecommunications network 107. According to techniques known in the art, said telecommunications network 107 may comprise one or more local data networks operating, for example, in accordance with the IEEE 802 packet communication standard family; in the most basic case, the telecommunications network 107 may operate, at network and transport level, in accordance with the standard used in the Internet global data network (e.g., TCP/IP or UDP/IP).

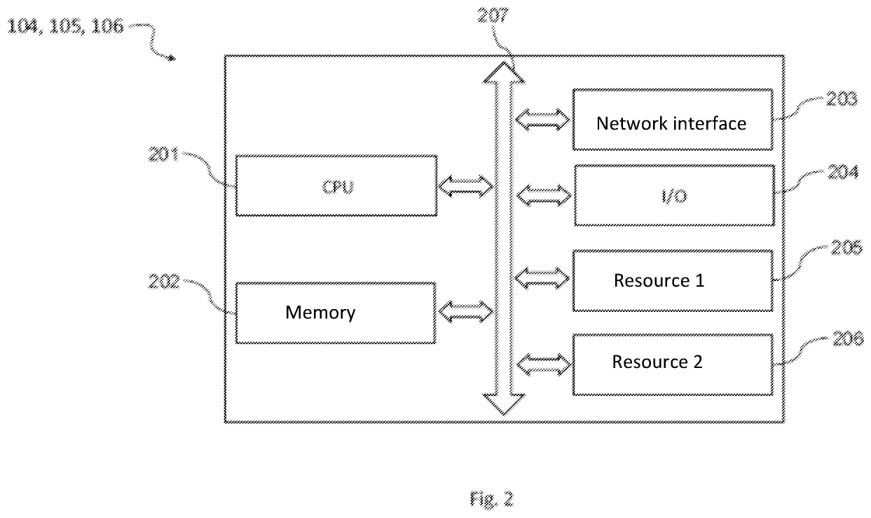

FIG. 2 shows a block diagram of a server 104, 105, 106 comprised in the cloud computing system 100 of the present invention. Merely by way of non-limiting example, each server 104, 105, 106 may comprise the following elements:
a processing unit 201 (e.g., one or more CPUs, GPUs, TPUs, DPUs or FPGAs);
a memory 202 (e.g., a random access memory RAM and/or a Flash memory and/or the like) operatively connected to said processing unit 201 and configured for storing at least a part of the instructions adapted to execute one or more functions of the resource management system of the cloud computing system 100;
one or more network interfaces 203 adapted to allow data transmission and reception over said telecommunications network 107;
input/output (I/O) means 204 adapted to allow, for instance, a person skilled in the art to configure the server 104, 105, 106;
one or more resources 205, 206 configured for being shared by a plurality of user equipments 101, 102, 103 (also referred to as shared resources in the present description);
a communication bus 207 configured for operatively connecting the processing unit 201, the memory 202, the input/output means 205, and the resources 205, 206.

The shared resources 205, 206 may be of different types and may comprise physical or virtual hardware resources, storage resources, computational resources, data transmission resources, software services, etc.; as aforementioned, the present invention is not limited to a particular type of resource or service provided by the servers 104, 105, 106 of the cloud computing system 100; on the contrary, it is applicable with no modification to any type of resource or service made available by the cloud system 100.

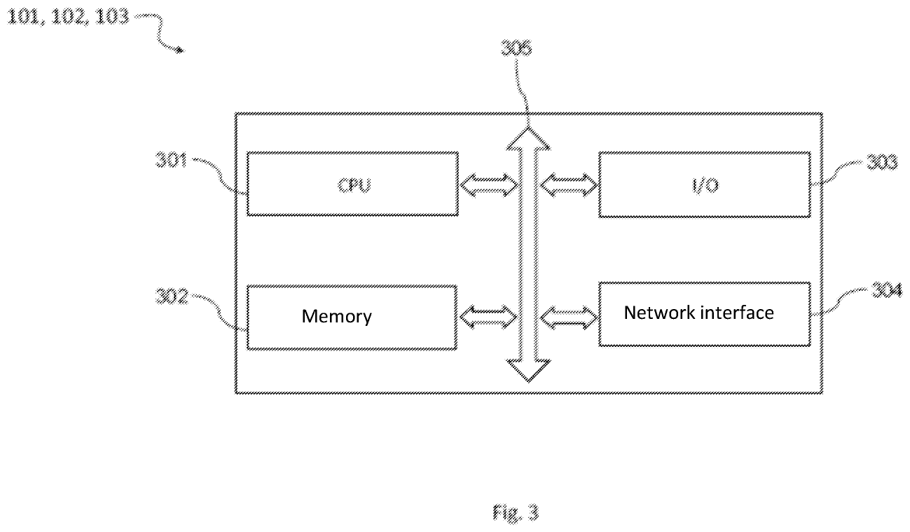

FIG. 3 shows a block diagram of a user equipment 101, 102, 103 comprised in the cloud computing system 100 of the present invention. Merely by way of non-limiting example, each user equipment 101, 102, 103 may comprise the following elements:
a processing unit 301 (e.g., one or more CPUs, GPUs, TPUs, DPUs or FPGAs);
a memory 302 (e.g., a random access memory RAM and/or a Flash memory and/or the like) operatively connected to said processing unit 301 and configured for storing at least a part of the instructions adapted for interfacing with the resource management system of the cloud computing system 100;
input/output (I/O) means 303 adapted to allow one or more users to configure the user equipment 101, 102, 103;
one or more network interfaces 304 adapted to allow data transmission and reception over said telecommunications network 107.

In general, a user equipment 101, 102, 103 may be comprised in a laptop computer, a smartphone, a personal computer, etc.; in addition, a user equipment 101, 102, 103 may be comprised in an infotainment system of a motor vehicle or in the electronic control unit of a household electronic apparatus. Moreover, the functions of a user equipment 101, 102, 103 concerning the protocol for sharing and selecting a shared resource in the cloud computing system 100 may be managed by a virtual device.

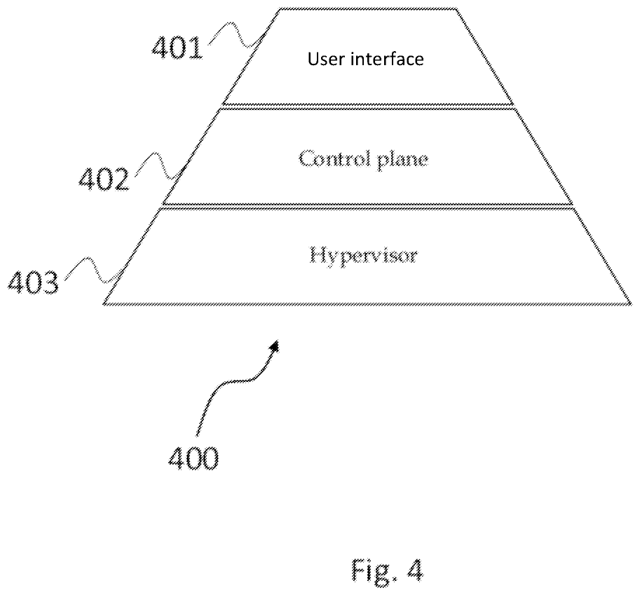

According to one aspect of the present invention, the cloud computing system may comprise a resource management system configured for administering the services provided by the cloud system; for example, a resource management system may be configured for interfacing with a plurality of users, so as to receive resource requests from the latter, conduct one or more searches in the servers 104, 105, 106 comprised in the system 100, allocate the resources 205, 206, etc. Merely by way of example, FIG. 4 shows a resource management system 400 of a cloud computing system 100 comprising a virtualization framework configured for abstracting the hardware held by each one of the servers of the cloud system. The resource management system 400 of the cloud computing system 100 may comprise a user interface 401 configured to, for example, allow the users 101, 102, 103 of the cloud computing system 100 to request the allocation of one or more resources held from the system 100. The resource management system 400 of the cloud computing system 100 may further comprise a control plane 402 configured to, for example, administer the access to the resources of the cloud computing system 100, manage the search for resources requested by the users 101, 102, 103, manage the service for booking and monitoring such resources (also referred to as “bookkeeping” in the present description), etc. For example, the user interface 401 and the control plane 402 of the cloud computing system 100 may comprise solutions known in the art such as, for example, VMware vSphere WebUI, Openstack WebUI, Proxmox WebUI, Microsoft Hyper-V, Citrix XenCenter, Xen Orchestra, Red Hat Enterprise Virtualization and oVirt, etc. The resource management system 400 of the cloud computing system 100 may comprise a module 403 adapted for the creation of one or more virtual machines within each server 104, 105, 106; for example, the module 403 may comprise one or more hypervisors known in the art such as, for example, VMware vSphere, Linux KVM, Citrix Xen, Microsoft Hyper-V, XCP-ng, etc. The modules 401, 402, 403 of the resource management system 400 can be implemented through a plurality of hardware and software components in a partially or fully distributed manner in the servers 104, 105, 106 of the cloud computing system and/or in the user equipments 101, 102, 103.

According to one aspect of the present invention, the mechanism for searching for resources within the cloud computing system 100 may be fully distributed, e.g., provided through a distributed implementation of the control plane module 402 of the resource management system 400. In this case, the control plane module 402, and particularly the resource search mechanism, can be implemented by means of a plurality of software and/or hardware components distributed among one or more user equipments 101, 102, 103 and one or more servers 104, 105, 106 comprised in the cloud computing system 100; in this case, the resources requested by one or more users 101, 102, 103 can be searched for without using a centralized resource catalogue. Such a distributed resource search mechanism may comprise a communication protocol for sharing and selecting a resource, implemented at control plane level, which, through a plurality of messages exchanged between one or more user equipments 101, 102, 103 and one or more servers 104, 105, 106, can implement the functions of searching, selecting and sharing one or more shared resources 205, 206.

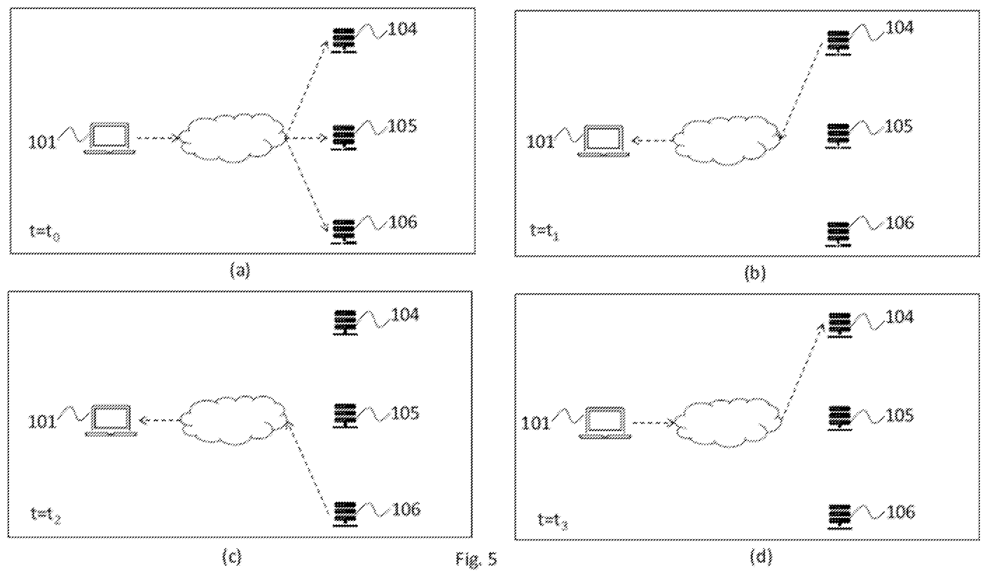

FIG. 5 shows a figurative example of the steps executed by the communication protocol for searching for one or more resources in a cloud computing system 100 according to the present invention. FIG. 5(a) represents the step executed by the protocol at the instant t=t₀; FIG. 5(b) represents the step executed by the protocol at the instant t=t₁ following to; FIG. 5(c) represents the step executed by the protocol at the instant t=t₂ following t₁, and, lastly, FIG. 5(d) represents the step executed by the protocol at the instant t=t₃ following t₂. As shown in FIG. 5(a), the user equipment 101 can generate a request message comprising at least one piece of information identifying said one or more resources (also referred to as message for requesting one or more resources in the course of the present description). According to one aspect of the present invention, said message for requesting one or more resources can be transmitted by said user equipment 101, via the telecommunications network 107, to at least one server 104, 105, 106 of the cloud computing system 100. Generally, the message for requesting one or more resources can be sent by each user equipment 101, 102, 103 to a plurality of servers 104, 105, 106; for example, depending on the network technology adopted by the telecommunications network 107, the message for requesting one or more resources may be addressed in broadcast mode, so that it can be delivered to a plurality of server 104, 105, 106. The communication protocol for searching for one or more resources according to the present invention comprises a second step in which the message for requesting one or more resources is received by at least one server 104, 105, 106 of the cloud system 100. As shown in FIG. 5(b) and FIG. 5(c), the servers 104, 105, 106 of the cloud computing system 100 can transmit over the telecommunications network 107, depending on the actual availability of the resources specified in the request message, a reply message at a predetermined instant of transmission. For example, in FIG. 5(b) a first reply message is transmitted by the server 104 to the user equipment 101 at a first instant of transmission t=t₁; similarly, as shown in FIG. 5(c), a second reply message is transmitted by the server 104 and sent to the user equipment 101 at a second instant of transmission t=t₂. In the example shown in FIG. 5, the server 105 may avoid the transmission of the reply message; the protocol for sharing and selecting resources according to the present invention may, in fact, be configured for not compelling the servers 104, 105, 106 of the system 100 to send a reply. In the example of FIG. 5, the server 105 may not have the resources requested by the user equipment 101, or may intentionally not grant the use of the requested resources to the user equipment 101.

As will be explained in detail below, the instant of transmission of the reply message can be computed as a function of a utilization index of the shared resources comprised in said at least one server; for example, said resource utilization index may have a value which is directly proportional to the number of shared resources 205, 206 that, at the instant of reception of the resource request message or in the time period in which the request message is processed by the server 104, 105, 106, are in used state. More generally, the protocol for sharing and selecting resources according to the present invention may use, for computing the utilization index, any predetermined relation between the utilization index and the number of shared resources 205, 206 that, at the instant of reception of the resource request message or in the time period in which the request message is processed by the server 104, 105, 106, are in used state. As will be further explained below, in order to implement one or more load balancing strategies in the system 100, such relation between the utilization index and the resources in used state preferably has to be known to at least a plurality of servers 104, 105, 106 and a plurality of users 101, 102, 103. In the course of the present description, the expression “resource in used state” will refer to any resource 205, 206 comprised in the server 104, 105, 106 which cannot be shared with the user equipment 101. For example, a shared resource 205, 206 may have been allocated to and/or be used by a user equipment 102, 103 other than the user equipment 101 at the instant of reception of the request message or in the time period in which such request message is processed by the server 104, 105, 106; in such a case, that shared resource 205, 206 will be in used state, since it cannot be shared with the user equipment 101. Moreover, the index of utilization of the shared resources 205, 206 may take a percentage value as a function of the total number of shared resources 205, 206 comprised in the server 104, 105, 106 and the number of shared resources 205, 206 in used state; in other words, the index of utilization of the resources of each server 104, 105, 106 may represent the ratio or percentage value of the shared resources 205, 206 in used state relative to the total number of shared resources 205, 206 comprised in the server 104, 105, 106. For example, assuming that a server 104, 105, 106 comprises a total number X of shared resources 205, 206 and that a number Y of such shared resources are in used state, the index of utilization of the server 104, 105, 106 may be the Y/X ratio. As previously described, the index of utilization may be computed according to any relation involving the number of resources in used state. In the example depicted in FIGS. 5(b) and 5(c), it has been assumed that the index of utilization of the shared resources of the server 104 and the index of utilization of the shared resources of the server 106 have distinct values. In particular, the ratio between the number of resources in used state and the total number of shared resources held by the server 104 is different from the ratio between the number of resources in used state and the total number of shared resources of the server 106. In other words, the workload of the server 104 at the instant of reception of the resource request message or in the time period in which such message is processed is different from the workload of the server 106; it follows that the first instant of transmission t=t₁ of the first reply message of the server 104 will be different from the second instant of transmission t=t₂ of the second reply message transmitted by the server 106. Alternatively or additionally, the index of utilization may be computed as a function of the ratio between the sum of the number of resources in used state and the number of requested resources and the total number of resources held by the server 104, 105, 106. In this way, the index of utilization will indirectly represent the workload that the server would have to handle if the resources requested in the resource request message were actually allocated to the server 104, 105, 106 in question. It is understood that the index of utilization of each server 104, 105, 106 and the instant of transmission of the reply message may be computed in many ways; for example, the instant of transmission of the reply message of each server 104, 105, 106 may be either directly proportional to the workload of the server 104, 105, 106 or indirectly proportional to the workload of the server 104, 105, 106. Regardless of the adopted method of computation, the instant of transmission of the reply messages provides the user equipments 101, 102, 103 with an indirect indication about the workload of each one of the servers 104, 105, 106.

The communication protocol for searching for one or more resources according to the present invention comprises a further step in which one or more reply messages originated from one or more servers 104, 105, 106 comprised in the system 100 are received by the user equipment 101 via the telecommunications network 107. Each one of such reply messages may contain an explicit indication about the availability of the resources requested by the equipment 101 in the resource request message. In the example shown in FIG. 5(b) and FIG. 5(c), the user equipment 101 receives a first reply message from the server 104 at a first instant of reception and a second reply message from the server 106 at a second instant of reception. For simplicity, in the example shown in FIG. 5 it has been assumed that the transmission delay between any two nodes of the telecommunications network 107 is negligible or has a fixed value Δtₚ. As a consequence, in the example shown in FIG. 5 the first instant of reception coincides with the first instant of transmission t=t₁ or, alternatively, with an instant of reception t=t₁+Δtₚ. Likewise, the second instant of reception coincides with the second instant of transmission t=t₂ or, alternatively, with an instant of reception t=t₂+Δtₚ.

Because the time succession according to which the reply messages are received by the user equipment 101 is concordant with the order of the instants of transmission of the reply messages from the server 104 and from the server 106, the first instant of reception and the second instant of reception provide an indirect indication about the value of the index of utilization, and hence of the workload of each server 104, 106. In order to implement one or more load balancing strategies in the cloud computing system 100, the user equipment 101 can conveniently select the server providing said resource between the server 104 and the server 106 as a function of the first instant of reception and the second instant of reception; in the course of the present description, the expression “provider server” will indicate that server 104, 105, 106 which will be actually requested to share its resources by means of an allocation message. Such allocation message may contain information about the resource allocation request from the user equipment; in other words, the resource allocation message sent by the user equipment indicates that the user equipment wants to use the shared resources 205, 206 identified through the resource sharing and searching protocol. In particular, since the first instant of reception and the second instant of reception provide an indirect indication about the workloads of the servers 104, 106, the user equipment 101 can select the server that will provide the requested resources in accordance with one or more load balancing strategies implemented for the system 100.

In particular, in the example shown in FIG. 5 the first reply message from the server 104 is received at a first instant of reception that precedes the second instant of reception of the second reply message; consequently, for the above-explained reasons, the user equipment 101 can infer that, for example, the workload of the server 104 is lower than the workload of the server 106. Thus, the user equipment 101 can suitably choose the server that will provide the service between the server 104 and the server 106 so as to, for example, even out the workloads of the servers 104, 105, 106 of the system 100. In the example shown in FIG. 5(d), the user equipment may select the server 104 as provider server and send to the server 104 a message for allocating the requested resources.

Because the cloud computing system 100 according to the present invention is made up of a plurality of distributed components operatively connected by means of a telecommunications network 107, the steps executed by the protocol for sharing and selecting resources in the system 100 are necessarily distributed among the components of the system 100. Therefore, it is understood that, in order to allow the user equipments 101, 102, 103 to infer the workloads of the servers 104, 105, 106 as a function of the instants of reception of the reply messages sent by such servers 104, 105, 106, it is appropriate that the user equipments 101, 102, 103 know how each server computes the index of utilization and the instant of transmission of each reply message.

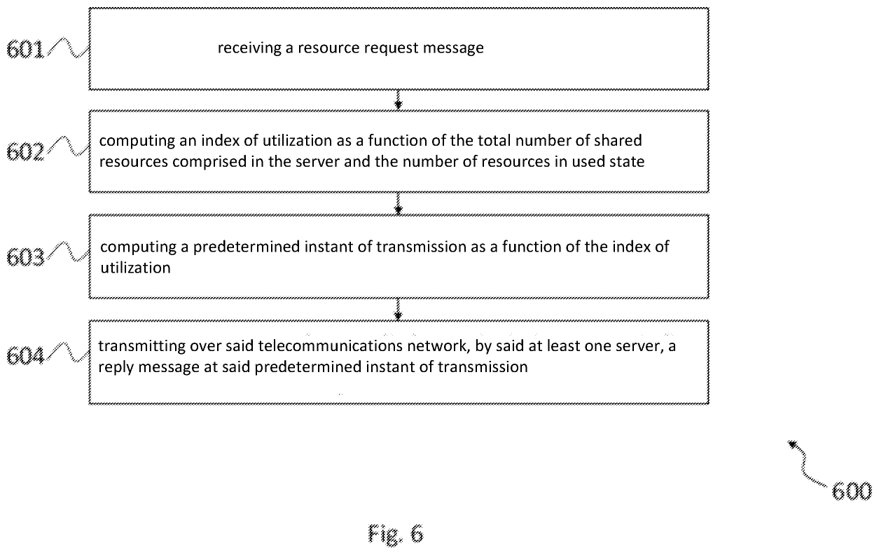

In particular, FIG. 6 shows a diagram of the method 600 for sharing a resource in a cloud computing system 100 according to the present invention; such method represents a part of the protocol for sharing and selecting resources in the system 100, executed by one or more servers 104, 105, 106 of the system 100. As shown in FIG. 6, the method 600 comprises a first step 601 in which a server 104, 105 or 106 comprised in the system 100 receives a message requesting one or more resources; the method 600 further comprises a step 602 in which a server 104, 105 or 106 computes an index of utilization of its own shared resources. For example, such index of utilization may be computed as a function of the total number of shared resources comprised in the server 104, 105 or 106 and the number of resources in used state comprised in the server 104, 105 or 106; alternatively, the index of utilization may coincide with the number of resources in used state. The method 600 further comprises a step 603 in which the server 104, 105 or 106 computes a predetermined instant of transmission as a function of the index of utilization; lastly, at step 604 the server 104, 105 or 106 transmits, over said telecommunications network 107, a reply message at said predetermined instant of transmission. For example, the server 104, 105 or 106 may determine an instant of transmission by storing the instant of reception of the resource request message and calculating a transmission delay as a function of said index of utilization of said one or more shared resources. For example, the transmission delay may be calculated in such a way as to be directly proportional to the index of utilization of the resources of each server 104, 105 or 106. In this way, the higher the workload of a given server 104, 105 or 106, the longer the transmission delay of the reply message that will be sent by that server 104, 105, 106. Alternatively, the instant of transmission may be calculated in such a way as to be indirectly proportional to the index of utilization of the resources of each server 104, 105 or 106. In other words, according to one aspect of the present invention, each server can, generally speaking, reply to the resource request message with a delay which will vary depending on the workload of that server (i.e., as a function of the number of shared resources currently in use). The method 600 for sharing a resource depicted in FIG. 6 and described above can advantageously be implemented as a computer program; in such a case, said computer program can be installed in the memory 202 of one or more servers 104, 105, 106, and may comprise a plurality of instructions that, when executed by the processing unit 201 of the server 104, 105, 106, will cause said server 104, 105, 106 to execute the steps of the method 600.

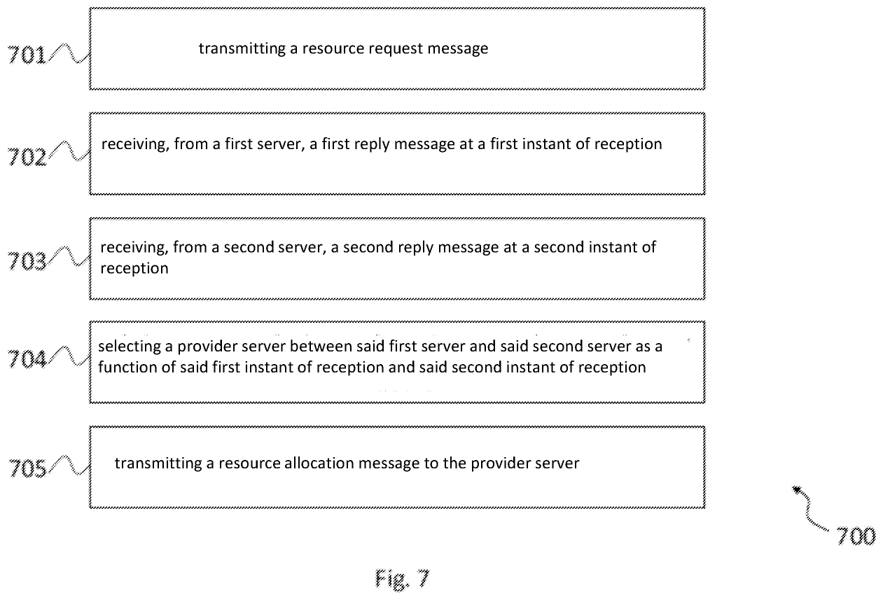

FIG. 7 shows a diagram of the method for selecting a resource in a cloud computing system 100 according to the present invention; such method represents a part of the protocol for sharing and selecting resources in the system 100, executed by one or more user equipments 101, 102, 103 of the system 100. As shown in FIG. 7, the method 700 comprises a first step 701 in which a user equipment 101, 102 or 103 transmits a message requesting one or more resources; such message requesting one or more resources may contain information identifying said one or more resources. The method 700 further comprises a second step 702 in which said user equipment 101, 102 or 103 receives a first reply message, at a first instant of reception, from a first server 104, 105 or 106, and a third step 703 in which said user equipment 101, 102 or 103 receives a second reply message, at a second instant of reception, from a second server 104, 105 or 106. The method 700 further comprises a step 704 in which the user equipment 101, 102 or 103 selects a provider server between said first server 104, 105 or 106 and said second server 104, 105 or 106 as a function of the first instant of reception and the second instant of reception. In other words, the reception of two or more reply messages indicates the need for making a choice among the servers 104, 105 or 106 (i.e. among the servers 104, 105, 106 from which the user equipment 101, 102, 103 has received at least one reply message), so as to identify the server 104, 105, 106 that will be asked to share the requested resources (i.e. the provider server). According to one aspect of the present invention, this selection is made by the user equipment 101, 102, 103 on the basis of the first instant of reception and the second instant of reception. As previously described herein, the order of arrival of the reply messages (i.e. the time succession of the first instant of reception and second instant of reception) implicitly indicates the workloads of the servers 104, 105, 106. The selection of the provider server can thus be made in accordance with a specific load balancing strategy. For example, the user equipment 101, 102, 103 may choose that server 104, 105, 106 whose reply message has been received at an instant of reception indicating a workload which is lower than that of the other servers 104, 105, 106 of the system 100; for example, if the instant of transmission of the reply messages is computed in such a way as to be directly proportional to the workload of the server 104, 105, 106, then the user equipment 101, 102, 103 may choose, as provider server, that server 104, 105, 106 whose reply message has been received earlier than the reply messages of the other servers. It will thus be possible to implement a load balancing strategy that will distribute the workload evenly among the servers 104, 105, 106 of the system 100. Alternatively, the user equipment 101, 102, 103 may choose that server 104, 105, 106 whose reply message has been received at an instant of reception indicating a workload which is higher than that of the other servers 104, 105, 106 of the system 100. It will thus be possible to implement a load balancing strategy that will distribute the workload unevenly among the servers 104, 105, 106 of the system 100. It is understood that the protocol for sharing and selecting one or more resources according to the present invention may likewise be used for implementing any load balancing strategy known in the art (e.g., equal load balancing, unequal load balancing, etc.). Lastly, the method 700 comprises a step 705 in which the user equipment 101, 102, 103 transmits a resource allocation message to the provider server; the resource allocation message may comprise one or more instructions adapted to allocate the requested resources on the provider server. The method 700 for selecting a resource previously described herein and depicted in FIG. 7 can advantageously be implemented as a computer program; in such a case, said computer program can be installed in the memory 302 of one or more user equipments 101, 102, 103, and may comprise a plurality of instructions that, when executed by the processor 301 of the user equipment 104, 105, 106, will cause said user equipment 101, 102, 103 to execute the steps of the method 700.

The cloud computing system 100, the servers 104, 105, 106, the user equipments 101, 102, 103, the method 600 for sharing a resource, the method 700 for selecting a resource, and the computer programs associated therewith according to the present invention offer several advantages over the cloud computing systems currently known in the art. For example, the present invention advantageously permits the implementation of one or more load balancing strategies in a cloud computing system 100 lacking a centralized resource catalogue. As previously described herein, the present invention allows the user equipments 101, 102, 103 to indirectly receive an indication about the workloads of the servers 104, 105, 106 comprised in the cloud computing system 100. A further advantage of the present invention lies in the fact that it provides an indication about the workloads of the servers 104, 105, 106 without however disclosing any specific information about the configuration of the servers 104, 105, 106.

Of course, without prejudice to the principle of the present invention, the embodiments and the implementation details may be extensively varied from those described and illustrated herein merely by way of non-limiting example, without however departing from the protection scope of the present invention as set out in the appended claims.

1. A method for sharing a resource in a cloud computing system, said cloud computing system comprising a plurality of servers operatively connected to one another by means of a telecommunications network, each server of said cloud computing system comprising one or more shared resources, said method comprising the following steps:
receiving on at least one server a message requesting said resource;
transmitting over said telecommunications network, by said at least one server, a reply message at a predetermined instant of transmission;
wherein said predetermined instant of transmission is computed as a function of a utilization index of said one or more shared resources comprised in said at least one server.

2. The method for sharing a resource in a cloud computing system according to claim 1, further comprising the following steps:
computing said utilization index as a function of a total number of said one or more shared resources comprised in said at least one server and a number of said one or more shared resources currently in use.

3. The method for sharing a resource in a cloud computing system according to claim 1, further comprising the following steps:
determining an instant of reception of said resource request message;
computing a transmission delay as a function of said utilization index of said one or more shared resources;
determining said instant of transmission based on said transmission delay and said instant of reception.

4. The method for sharing a resource in a cloud computing system according to claim 1, wherein said reply message comprises information about the availability of said resource.

5. A method for selecting a resource in a cloud computing system, said cloud computing system comprising a plurality of servers and at least one user equipment operatively connected to one another by means of a telecommunications network, each server of said cloud computing system comprising one or more shared resources, said method comprising the following steps:
transmitting over said telecommunications network, by said user equipment, a message requesting said resource;
receiving on said user equipment, from a first server comprised in said plurality of servers, a first reply message at a first instant of reception;
receiving on said user equipment, from a second server comprised in said plurality of servers, a second reply message at a second instant of reception;
wherein said method further comprises the following steps:
selecting at least one provider server providing said resource between said first server and said second server as a function of said first instant of reception and said second instant of reception;
transmitting to said at least one provider server, over said telecommunications network, a message allocating said resource.

6. Server A server adapted for sharing a resource in a cloud computing system, said server comprising:
memory means;
a network interface;
one or more shared resources;
a processing unit operatively connected to said memory means, said network interface and said one or more shared resources;
said processing unit being configured to execute the steps of the method for sharing a resource in a cloud computing system according to claim 1.

7. A user equipment adapted for selecting a resource in a cloud computing system, said user equipment comprising:
memory means;
a network interface;
a processing unit operatively connected to said memory means and said network interface;
said processing unit being configured to execute the steps of the method for selecting a resource in a cloud computing system according to claim 5.

8. A cloud computing system comprising a plurality of servers operatively connected to one another by means of a telecommunications network, wherein each one of said servers is configured to execute the method according to claim 1.

9. A computer program for sharing a resource in a cloud computing system, comprising a plurality of instructions that, when executed on a processing apparatus, cause said processing apparatus to execute the steps of the method according to one or more of claim 1.

10. The computer program for selecting a resource in a cloud computing system, comprising a plurality of instructions that, when executed on a processing apparatus, cause said processing apparatus to execute the steps of the method according to claim 5.
